(19) United States
(12) Patent Application Publication
(10) Pub. No.: US 2002/0184530 A1
(43) Pub. Date: Dec. 5, 2002

(54) Apparatus and method of uploading and downloading anonymous data to and from a central database by use of a key file

(76) Inventor: Ira Spector, Mineola, NY (US)

Correspondence Address: R Lewis Gable, Cowan Liebowitz & Latman, 1133 Avenue of the Americas, New York, NY, 10036-6799, US

(21) Appl. No.: 10/148,536

(22) PCT Filed: Oct. 4, 2001
(86) PCT No.: PCT/US01/31167

(51) Int. Cl. H04L 9/00; G06F 15/173

(52) U.S. Cl. 713/201; 709/223

(57) ABSTRACT

A method of maintaining the confidentiality of data of a client that is transmitted over a network between a server and one of a plurality of computer terminals is described. The method comprises the steps of partitioning the client's data into a first data file that identifies the identity of its client and includes an encoding/decoding program, and a second data file that is maintained anonymous. The method further facilitates each client to possess its first data file, and the storage of one or more anonymous second data files in the server's database without the corresponding first data file. Finally, the method facilitates the client to execute the encoding/decoding program on any one of the plurality of computer terminals to download from the server to the one computer terminal and decode the second data file or to encode and upload the second data file from the one computer to the server.

### BACKGROUND

Many methods of insuring the security and confidentiality of data exist on both the personal and corporate level. With the advent of web server technology and the internet, security has become even more critical. The problem is how to convey data over the internet where the conveyed data is accessible only to authorized parties, and while maintaining the security of that data. All previous methods of insuring confidentiality have relied on various forms of encryption and password protection with or without the protection of firewalls. However, should the server's integrity be compromised, either by a hacker from without or an employee from within, all of the data and information is readily available and immediately usable to the unauthorized third party.

Definitions

WEB SERVER-Database server that services their clients over the internet and contains the software to interface with the key file.

KEY FILE-The file that contains the identity file, key code generator, encryption software and software that allows the client to use the database. It remains with the client.

KEY CODE-The code that will allow the web server to find and download the client's information.

IDENTITY FILE-The file in the key file that contains the client's critical information fields.

### SUMMARY OF THE INVENTION

A method is described to insure the confidentiality of data that is uploaded and downloaded over a network, e.g., the internet, between a server and one of a plurality of client computer terminals. Maintaining the confidentiality of the data stored on a server depends on the partition of a client's information into an identity data file and an anonymous data file. The anonymous data is stored on the server. The identity data includes all data: 1) that can identify the owner or the subject of the information, or 2) that is critical for the use of the information. The anonymous data is stored on a database of the server, and is transmitted between the server and any of the terminals connected to the server via a network, e.g., the internet. On the other hand, the identity data is neither stored on the servers nor uploaded therefrom or down loaded therefrom, but rather is kept as a part of a key file, which not only includes the identity data but also a computer program which is adapted to be executed on one of the client computer terminals to encode (encrypt) and decode (decrypt) the anonymous data, and to upload and download the encoded anonymous data to and from the server. The key file may in turn be uploaded to a portable storage medium or memory, whereby the client may personally retain the key file, or it may be downloaded to any one of the client computer terminals to be executed. The client can use the key file by carrying it to any one of the plurality of client computer terminals and then downloading the key file to that terminal, whereby the encoded anonymous data file may be downloaded from the server to that one terminal, whereat it is decoded and linked or combined with the identity data, before being used by the client.

### DETAILED DESCRIPTION OF THE PREFERRED EMBODIMENT OF THE INVENTION

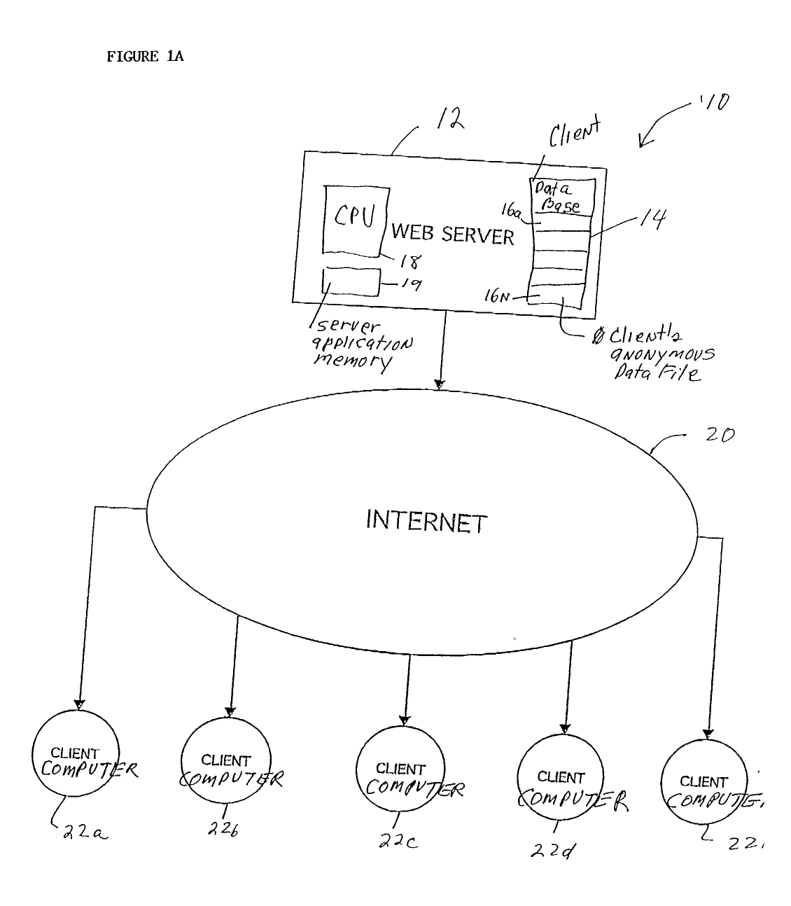

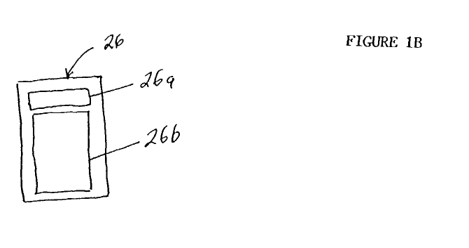

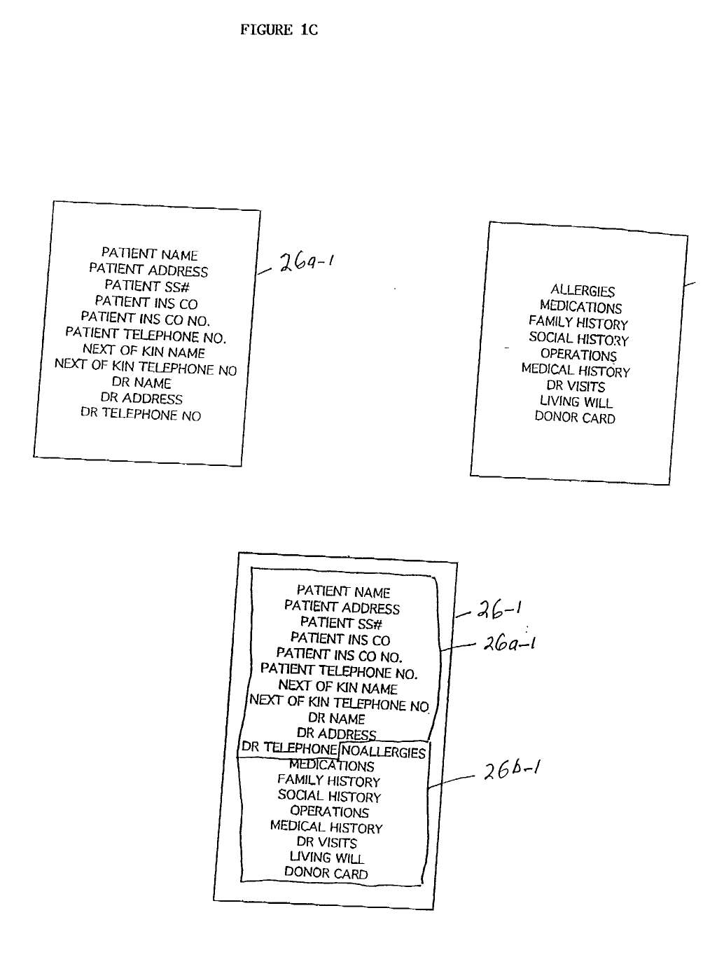

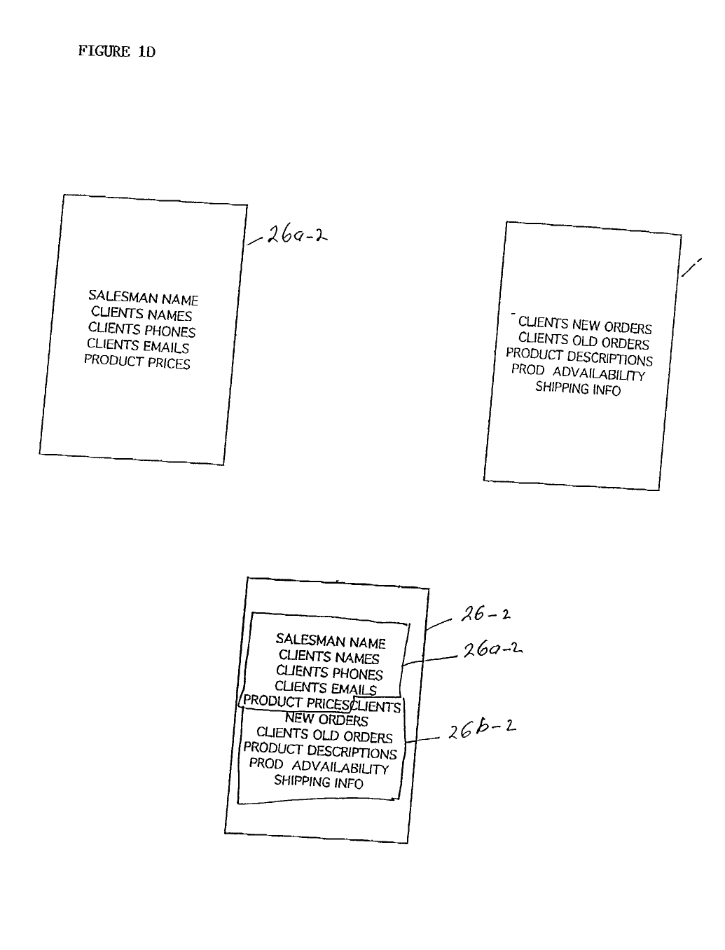

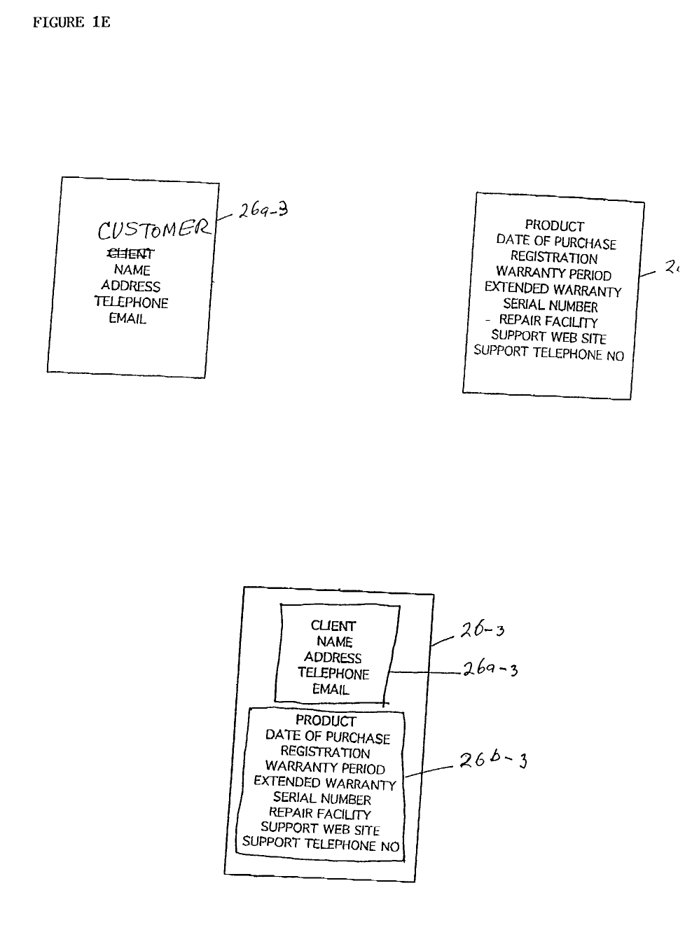

Referring now to the drawings and in particular to FIG. 1A, there is shown a secure data transmission system 10, whereby anonymous data is uploaded and downloaded to and from a centrally disposed database 14, whether corporate based or web based. The secure data transmission system 10 comprises a server 12, which includes the noted database 14 for storing the anonymous data of a plurality of clients, a CPU 19 and a memory 19 for storing a plurality of server application programs 92, 94 and 96. The database 14 is divided into a plurality of data files 16a- n, each file for storing the anonymous data of its corresponding user or client. The server 12 is in turn connected to a network 20. Though in a preferred embodiment of this invention the network may take the form of the internet 20, it is appreciated by those skilled in the art that the network could take the form of telephone lines, RF or other wireless data transmission systems, intranets etc. In turn, the internet 20 connects the server 14 to each of a plurality of client computer terminals 22a-n, whereby a client's anonymous data may uploaded from one of the client computer terminals 22 to be stored on the server 12 and, in particular, on the server's database 14, and downloaded from the database 14 to one of the plurality of computers 22a-n, potentially different from that terminal 22 from which the data was uploaded as will be explained below.

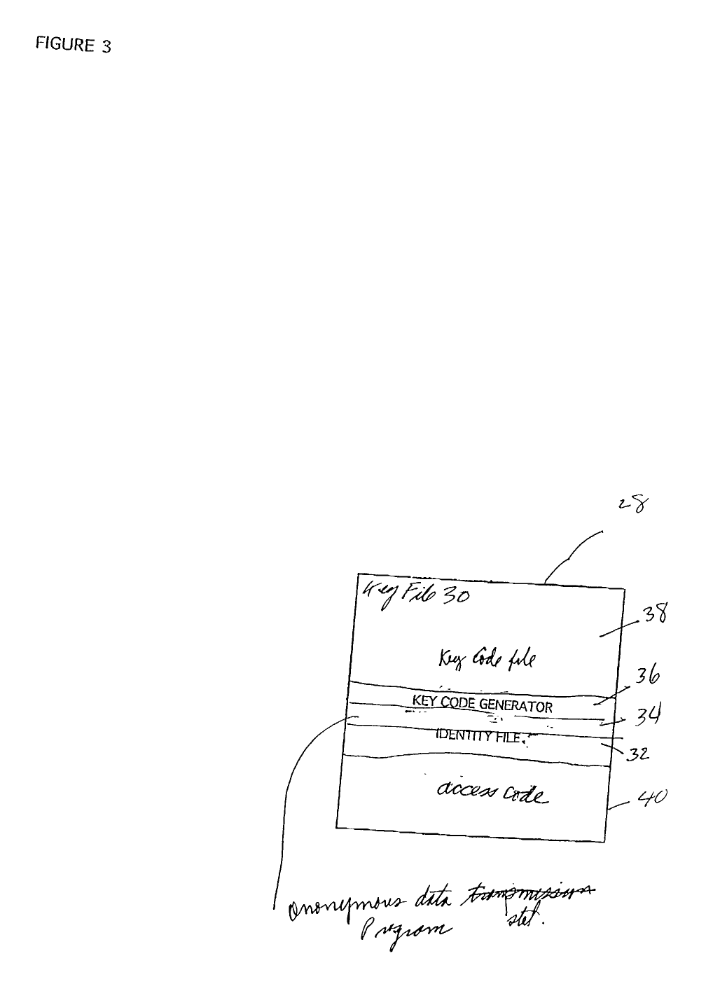

As will be explained below, the technology that provides the security is contained in a key file 30, which, in one preferred embodiment of this invention as shown in FIG. 3, takes the form of a portable memory 28 which may be kept in the sole possession of its client. The key file 30 is a data structure which comprises, as shown in FIG. 3, three storage locations for storing data or information, namely a location 32 for storing the identity data, a location 34 for storing an anonymous data transmission program 92 and a location 36 for storing a program for effecting a key code generator. These three storage locations 32, 34 and 36 may be downloaded from the key file 30 to be stored on the portable memory 28. Such a portable memory 28 is adapted to be carried by a client, whereby the client can carry that memory 28 any where in the world and download the three storage locations 32, 34 and 36 into any available client computer terminal 22 (FIG. 1A). As will be explained below in detail, the anonymous data, which is stored on the database 14 of server 12 (FIG. 1A) may upon a requested sent from the client computer terminal 22 that has been programmed with the key file 30, may be downloaded from the server's database 14 to the requesting client computer terminal 22.

By contrast, the identity file is not retained on the server's database 14, but rather is kept as a part of the key file 30. The identity data file contains data that can identify the owner or subject of the anonymous data or is critical to the use of the anonymous data. A further understanding of the identity file and the anonymous data may be acquired from an explanation of a document 26 as shown in FIG. 1B. The document 26 comprises a first part 26a, where the identity data file is represented, and a second part 26b, where the anonymous data is represented. In an illustrative embodiment, the document 26 may take the form of a medical record as shown in greater detail in FIG. 1C. In such an embodiment, a part 26b-1 representing the identity data file may illustratively comprise the medical records of a patient, whereas the part 26a-1 may illustratively comprise the name and other demographic information about the patient, e.g., address, next of kin, telephone number, name and address of physician, etc. As described above, only the anonymous data without the corresponding identity data filed is stored on the database 14 of the server, or is uploaded from or downloaded to the requesting client computer terminal 22. Thus if an unauthorized party gained access to the unauthorized data, it would be of little value because there is no identification of the owner or subject of the anonymous data. In this fashion, the security of the anonymous data is maintained. As will be discussed later, the anonymous data of part 26b and the identity data file of part 26a are only linked or combined together in the requesting client computer terminal 22. When so joined or linked, the whole document 26 may be used by the client. For example, the client may use a computer terminal 22 to revise and/or add information to the whole document 26. In the context of when the document 26 takes the form of a medical record, the user could input data regarding the current condition of the patient into the second part 26 that contains the anonymous data.

As would be appreciated by one skilled in the art, the document 26 may be used to represent data for many different applications. For example, FIG. 1D shows a document 26-2 that is adapted to represent orders taken by a salesperson. In such an embodiment, the first part 26a-2 represents the identity data including illustratively the salesperson's name, his client's names, phone numbers and addresses, and the product (or service) prices. The second part 26b-2 represents the anonymous data, which may illustratively take the form of the client's new and old orders, product descriptions and availability, shipping information, etc. In a still further embodiment of this invention as shown in FIG. 1E, a document 26-3 illustratively represents warranty information for certain products. The second part 26b-3 representing the anonymous data includes illustratively identification of the product, the date of purchase, the warranty period, registration, etc. A first part 26a-3 representing the identity data sets out the customer's and purchaser's name, their addresses and telephone numbers, etc.

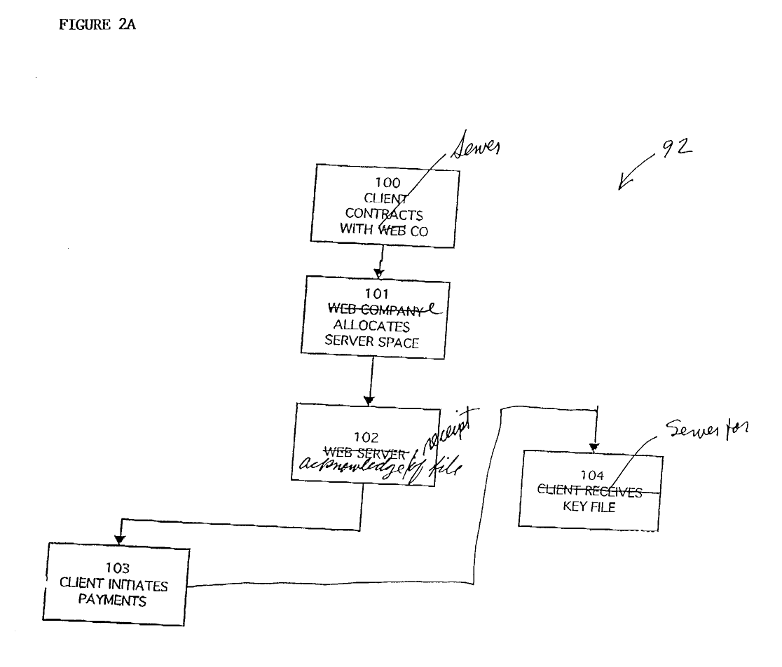

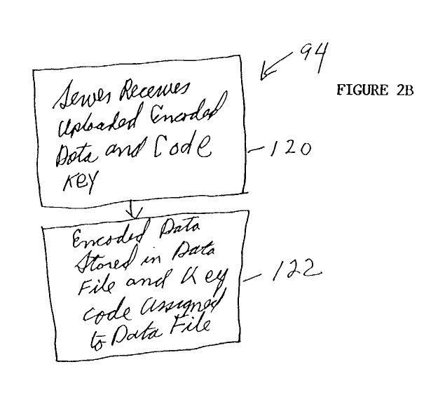

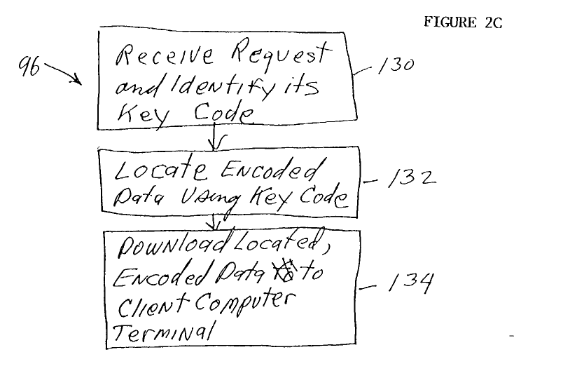

Referring now to FIG. 2A, there is shown the steps of a program 92, which is stored on the server's application memory 19 (FIG. 1A) and is executed by the server's CPU 18, as will be described below, to initialize or prepare the server 12 to receive and store the client's anonymous data on the client's database 14. Initially in step 100, the server 12 receives a request, which was entered by a client on its computer terminal 22 (FIG. 1A) and transmitted over the internet 20 to the server 12 to store the client's anonymous information and to receive a copy of the key file 30 with a blank identity file. The server 12 allocates in step 101 a certain amount of space within the server's database 14, into which one of the client's data files 16a-n that contains a particular client's anonymous data, may be uploaded. It is appreciated that the server's database 14 has a finite capacity, thereby requiring the server 12 to keep a running total of the space allocated to the client files to prevent overload of the database 14. Then, the server 12 transmits in step 102 over the internet 20 to the client computer terminal 22 from which the request originated, a message confirming that a client data file 16 had been allocated space in the database 14 and to prompt the client to submit the appropriate payment for use of the server 12. Next, step 103 determines whether the client has made the requested payment. The key file 30 also stores an indication (not shown) of the storage space limits of that client's space within the database 14 of the server 12 and will notify the client when more space is needed and must be paid for.

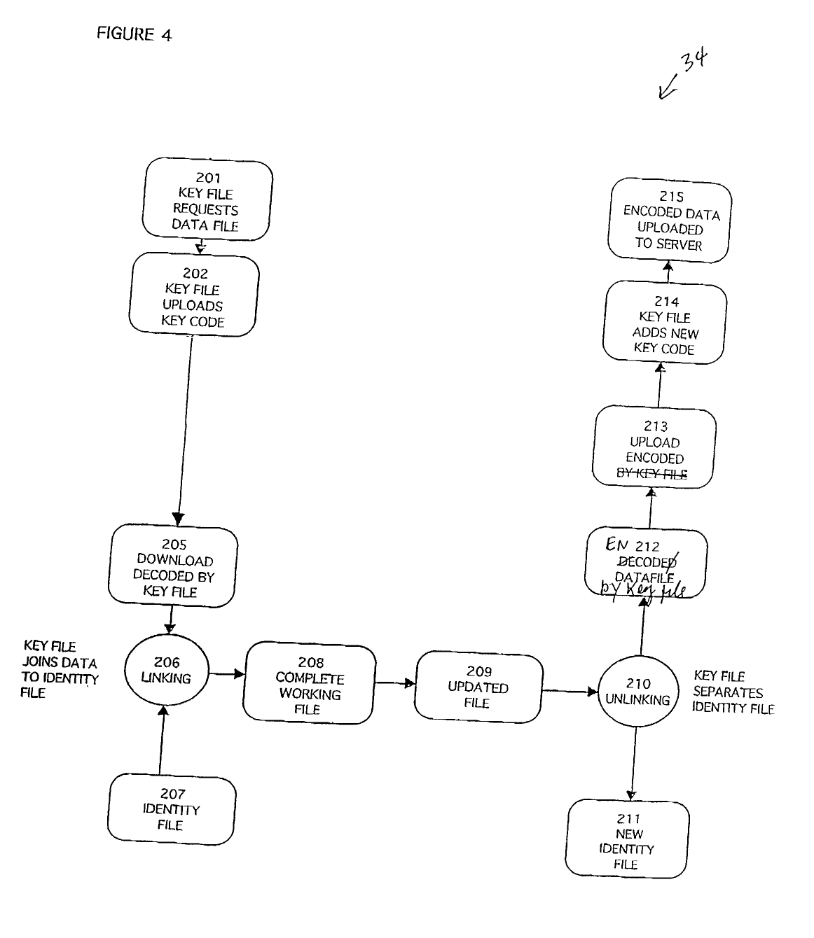

When step 103 determines that payment has been made, the process moves to step 104, whereby the server 12 then sends to the client in step 104 the key file 30 that contains: 1) a blank field 32 which is ready to receive the identity file, i.e., that data that identifies the owner of or the subject of the anonymous data, or is critical to the use of the information that will reside on the server 12, and 2) that application program 34, which is adapted to be executed on one of the client computer terminals 22a-n to upload and download the anonymous data and which includes steps 201-215, as will be described below with respect to FIG. 4. In the illustrative example described above with respect to FIG. 1C, the data, e.g., the next of kin and doctor contact information, is an example of data that is deemed to be necessary to use the related anonymous data, e.g., the patient's medical records. It is appreciated that the identity file field 32 is initially blank and will be completed by the client who will fill in the identifying data as will be described below. After a copy of the key file 30 has been downloaded in step 104 to the one client computer terminal 22 from which the original request was generated in step 100, the client may execute the anonymous data transmission program 34 at that particular computer terminal 22, or may transfer and store the key file 30 to the portable memory 28.

At a later time when the client needs to access and/or use the anonymous data from that data file 16 that was stored in the server's database 14, the client can transfer the key file 30 from its portable memory 28 to any convenient computer terminal 22 and use that computer terminal 22 to access and download the client's anonymous data from the database 14 of the server 12 to that requesting computer terminal 22. In particular, the client actuates its terminal 22 to execute the anonymous data transmission program 34 of the key file 30 which causes, as will be explained below in detail with respect to FIG. 4, the anonymous data transmission program 34 to unlink or separate the identity file from the anonymous data 26b and to encrypt the anonymous data, and the key code generator 36 to randomly generate and assign a key code to the encrypted anonymous data 26. The encrypted anonymous data and its related key code is then uploaded to the server 12. The client file 16 bearing the anonymous data is stored in the available space of the database 14, and the key code is assigned to the client's anonymous data file 16.

The server 12 then calls and executes a data retrieving program 96, as shown in FIG. 2C, to receive and input the uploaded anonymous data contained in one of the client's data files 16 to the database 14. In particular, the server 12 receives the uploaded data and recognizes in step 130 the key code and assigns it to the client data file 14 containing encrypted anonymous data, and uses in step 130 that key code as an address to identify which of the anonymous data files 16a-n that contains the anonymous data of this particular client. As will be explained later, this client saves the assigned key code in its key file 30, so that at a later time the client can request and supply this key code to the server 12, whereby the server 12 can use the key code to locate that data file 16 where the client's anonymous data is now stored and to download in step 134 that data to the requesting computer terminal 22.

When a client wishes to download and use its anonymous data that is stored on the database 14 residing on the server 12, the client downloads its key file 30 onto its computer terminal 22. The key file 30 includes as discussed above the anonymous data transmission program 34, which as shown in FIG. 4 serves to download the client's anonymous data to the client's computer terminal 22 (FIG. 1A). Initially in step 201, the client actuates its computer terminal 22 to start the process of downloading the client's anonymous data from the database 14 residing on the server 12. The client terminal 22 accesses the key file 30 to obtain from its key code file 38 that key code that was generated during the previous execution of the transmission program 34. Next, the client terminal 22 transmits in step 202 its request bearing its key code via the internet 20 (FIG. 1A) to the server 12. It will be appreciated that the client can not only download its entire data file 16, but also a selected record or records of that file dependent on which record(s) needs to be updated or otherwise used. Thus, the request generated in step 202 by the client also includes an appropriate indication as to which of the record(s) of the client's data file 16 should be downloaded. As will be explained with respect to FIG. 2B, the server 12 uses the key code as an address to locate that client's anonymous data file 16, where that client's data is stored. Then, the server 12 downloads the located anonymous data over the internet 20 to the requesting one of the plurality of the client computer terminals 22a-n. Then, the computer terminal 22 decodes or decrypts in step 205 the downloaded anonymous data and accesses in step 207 the identity data from the identifying file 32 stored in a memory of the terminal 22 (not shown), before the key file 30 links or combines in step 206 the decrypted anonymous data with the identifying data retained in the identifying file field 32 to produce in step 208 a complete working file 26 as shown in FIG. 1B. In step 209, the client can use the complete working file 26 by, for example, updating, revising and/or creating the complete working file 26. When the client has finished making its changes and a new complete file 26′ is produced, the client actuates its computer terminal 22 to unlink or to partition in step 210 the new complete working file 26′ into a new identity file 26a′ and a new client anonymous data file 26b′. Next in step 212, the transmission program 34 encodes or encrypts the new anonymous data file 26b′, before uploading that encoded anonymous data file in step 213 and actuating the key code generator program 36 to generate a new key code, which is attached in step 214 to encoded anonymous data file. Then, the encoded anonymous data file with its attached code key is uploaded in step 215 from the client's computer terminal 22 over the internet 20 to the server 12, where a data loading process 94 is executed by the CPU 18 (FIG. 1A) to assign the code key to one of the client's anonymous data files 16a-n where the uploaded anonymous data file is stored, as will be explained below with respect to FIG. 2B. In addition step 214 also retains the new key code in the key code file 38 of the key file 30, whereby the key code is available for the next client data request.

The server 12 responds to the anonymous data and the key code uploaded in step 215 (FIG. 4) of the transmission method 34 by executing the data loading process 94, which will now be explained with respect to FIG. 2B. First, step 120 receives the anonymous data and the attached key code. Next, step 122 loads the anonymous data into the available space (FIG. 1A) of the database 14 and assigns the received key code to that data file 16 into which the uploaded data was loaded. It is appreciated that the code or address assigned to each client data file 16 is changed each time the data loading process 94 and its code assigning step 122 are executed. The repetitively changing the code strengthens the security of the anonymous data. Also, the new code or address is assigned to the entire data file, regardless of whether the entire server's file 16 or only selected record(s) thereof are uploaded into the database 14. As discussed above, the key code that is uploaded in step 215, is saved in key code file 38 of the key file 30. That saved key code is used by the data retrieving program 96, as described above with respect to FIG. 2C, to send a request including that key code to retrieve the client's anonymous data from the database 14.

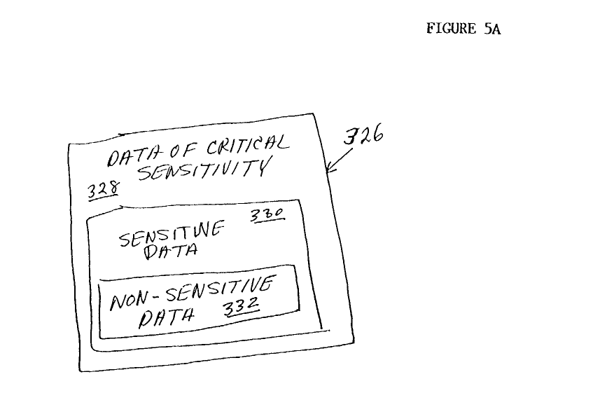

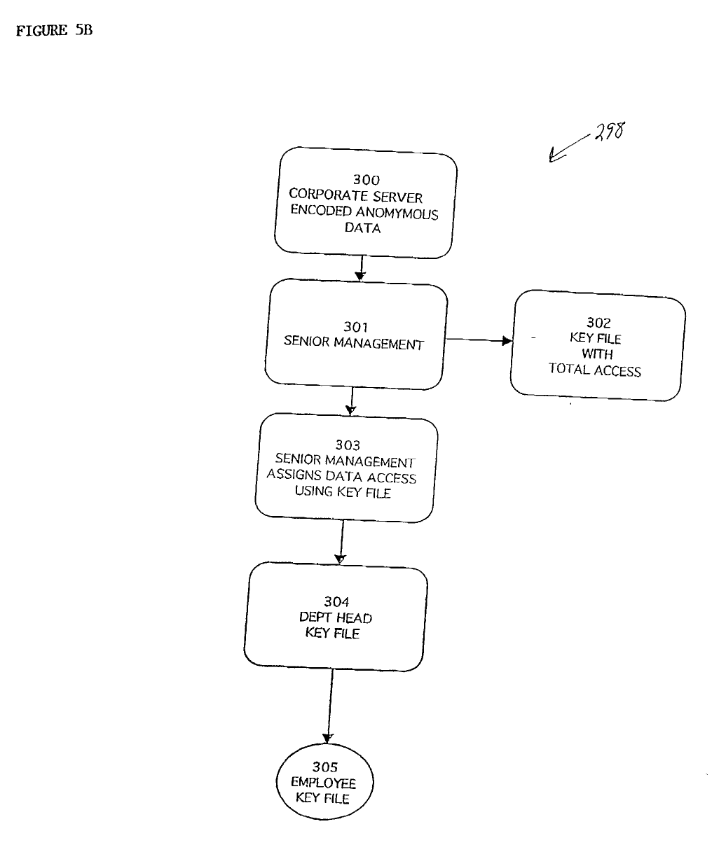

In a further embodiment of this invention, the key file 30 may be used to control access to a plurality of data sets, each data set having a different level of sensitivity or security. As shown in FIG. 5A, a document 326 contains a plurality of data sets, i.e., a first set 332 of non-sensitive data, a second 330 set of sensitive data and a third set 328 of data of critical sensitivity. A population of data users, e.g., employees of a company, is assigned different access levels to these data sets 328, 330 and 332. In the illustrative example of a company, employees belonging to senior management would be granted access to the data 328 of critical sensitivity as well as to the sensitive data 330 and the non-sensitive data 332. On the other hand, employees belonging to mid-management are given access only to the sensitive data 330 and the non-sensitive data 332. Non-management employees would only be given access to the non-sensitive data 332.

As shown in FIG. 5B, a method 298 of assigning data access codes is stored on the server application memory 19 (FIG. 1A) and is executed by the CPU 18 to assign the data access codes to the data users using the key file 30. As shown in FIG. 3, a data access code may be retained in a file 40 of the key file 30, whereby the client or user may use that code as will be explained below. Initially in step 300, the server 12 encodes the data and partitions the data into a plurality of parts or sets of data 328, 330 and 332 as explained above with respect to FIG. 5A. Next, access codes granting access to the data 328 of the critical sensitivity (as well as the sensitive data 330 and the non-sensitive data 332), are assigned to senior management 301, and such data access codes are inserted into the file 40 of the key file 30′. Then copies of that key file 30′ with total access are distributed to all of the senior management employees. In turn, the senior management employees are permitted to assign the lower level passwords to mid-management and non-management employees. Then in step 304, access codes for the sensitive data 330 and the non-sensitive data 332 are inserted into a key file 30″, and copies of those files 30″ are downloaded to the mid-management employees. Similarly, access codes for the non-sensitive data 332 are inserted into a key file 30′″, and copies thereof are downloaded to the non-management employees. It is appreciated that each employee may in turn load their key file 30′, 30″ or 30′″ into a client computer terminal 22, whereby each employee may access data stored on the server 12, but only that data to which that employee has been granted access by his or her data access password. It is appreciated that access data of different security levels is controlled by selectively providing copies of the key files 30′, 30″ and 30′″ to the members of the different groups dependent on the level of access to be given to each group.

Uploading and downloading of anonymous data with the key file 30 of this invention is applicable to all client-server databases whether private, corporate or on the internet 20. Having the key file 30 reside with the client puts the client in complete control of its data. The client is responsible for maintaining the integrity of the key file 30, providing for its safety and backing up the file 30. The client can use his computer terminal 22 to keep the key file 30 or the client can use any removable, portable storage media 28. In an alternative embodiment of this invention, password access to the key file 30 with the level of security needed for this particular situation on its client computer terminal 22 may be implemented. In other embodiments, clients can out source database functions to specialty companies and use the key file 30 with anonymous upload databasing in wired or wireless networks. The key file 30 can be kept on any computer terminal 22 or removable portable media 28 including, but not limited to, portable hard drives, Palm Pilots™, removable hard discs, optical drives, CD media, DVD media, MUD media, compact flash drives, smart media cards, memory sticks, ATA flash cards, credit card information strips or chips, or other suitable memories as would be known to one skilled in the art. Thus the client can take the key file 30 with its identity file data 26a (FIG. 1B) anywhere in the world and access its data with absolute security.

What is claimed is:

1. A method of maintaining the confidentiality of data of a client that is transmitted over a network between a server and one of a plurality of computer terminals, the server including a database, said method comprising the steps of:
a) partitioning the client's data into a first data file unit identifies the identity of its client that includes an encoding/decoding program and a second data file that is maintained anonymous;
b) facilitating each client to possess its first data file;
c) facilitating the storage of one or more anonymous second data files in the server's database without the corresponding first data file; and
d) facilitating the client to execute the encoding/decoding program on any one of the plurality of computer terminals to download from the server to one computer terminal and decode the second data file or to encode upload the second data file from the one computer to the server.

2. The method of maintaining data confidential as claims in claim 1, wherein step b) permits a client's first data file to be stored in a portable storage medium that the client may carry.

3. The method of maintaining data confidential as claimed in claim 2, wherein a client may download its first data file from its portable storage medium to any one of the plurality of computer terminals, thereby facilitating step d).
